(19) United States
(12) Patent Application Publication
(10) Pub. No.: US 2018/0087387 A1
(43) Pub. Date: Mar. 29, 2018

(54) COMPOSITIONS AND METHODS FOR COATING METAL TURBINE BLADE TIPS

(71) Applicant: General Electric Company, Schenectady, NY (US)

(72) Inventors: Jinjie Shi, Clifton Park, NY (US); Larry Steven Rosenzweig, Clifton Park, NY (US); Christopher Edward Wolfe, Niskayuna, NY (US); Dennis Paul Dry, Cincinnati, OH (US)

(21) Appl. No.: 15/278,821

(22) Filed: Sep. 28, 2016

(51) Int. Cl. F01D 5/28; F01D 25/24

(52) U.S. Cl. CPC F01D 5/288; F01D 25/24; F05D 2220/32; F05D 2230/90; F05D 2300/6033; F05D 2300/502; F05D 2300/175; F05D 2240/307; F05D 2300/611

(57) ABSTRACT

Coating systems for a turbine blade tip, such as a metal turbine blade tip, are provided. The coating system can include a thermal barrier coating on the surface of the turbine blade tip as well as one or more bond coats and/or metallic coatings. The coated blade tip can be used with a ceramic matrix composite shroud coated with an environmental barrier coating to reduce blade tip wear. Methods are also provided for applying the coating system onto a turbine blade tip.

### FIELD

Embodiments of the present invention generally relate to thermal barrier coatings for metallic components, particularly for use on a metal blade used in conjunction with a CMC shroud in a gas turbine engine.

### BACKGROUND

The turbine section of a gas turbine engine contains a rotor shaft and one or more turbine stages, each having a turbine disk (or rotor) mounted or otherwise carried by the shaft and turbine blades mounted to and radially extending from the periphery of the disk. A turbine assembly typically generates rotating shaft power by expanding hot compressed gas produced by combustion of a fuel. Gas turbine buckets or blades generally have an airfoil shape designed to convert the thermal and kinetic energy of the flow path gases into mechanical rotation of the rotor.

Within a turbine engine, a shroud is a ring of material surrounding the rotating blades. Ceramic matrix composites (CMCs) are an attractive material for turbine applications, particularly shrouds, because CMCs have high temperature capability and are light weight. However, CMC components must be protected with an environmental barrier coating (EBC) in turbine engine environments to avoid oxidation and recession in the presence of high temperature air flow.

Turbine performance and efficiency may be enhanced by reducing the space between the tip of the rotating blade and the stationary shroud to limit the flow of air over or around the tip of the blade that would otherwise bypass the blade. For example, a blade may be configured so that its tip fits close to the shroud during engine operation. Thus, generating and maintaining an efficient tip clearance is particularly desired for efficiency purposes.

During engine operation, the blade tips can sometimes rub against the shroud, thereby increasing the gap and resulting in a loss of efficiency, or in some cases, damaging or destroying the blade set.

To reduce the loss of efficiency, an abradable layer may be deposited on top of the EBC on the shroud. Generally, the abradable layer is a series of ceramic ridges that break away upon contact with a rotating blade tip. The ceramic material is typically made out of the same ceramic material as one of the environmental barrier layers, for example, rare earth disilicate or barium strontium aluminosilicate (BSAS). Current efforts in developing abradable materials for gas turbines rely on patterned (camberline, straight line, diamond) or flat (dense and porous) ceramic coatings for the EBC coated shroud while maintaining a reasonable erosion resistance.

However, the patterned ridges on the surface of the shroud reduce aerodynamic efficiency and tend to be more expensive and have less thermal protection. Additionally, a continuous ceramic layer is typically quite hard and does not abrade but rather abrades the tips of the rotating blades.

Due to extremely narrow sizes of blade tips, the application of protective coatings to the blade tip directly is difficult. Often, the airfoil, or body of the blade, rather than the blade tip is coated with a protective coating, due to the difficulty in applying coatings to the narrow blade tip.

Thus, an improved design of a turbine system using a metal blade and an EBC coated CMC component, particularly a shroud, is desirable in the art.

### BRIEF DESCRIPTION

Aspects and advantages of the invention will be set forth in part in the following description, or may be obvious from the description, or may be learned through practice of the invention.

A coated turbine blade is generally provided. The coated turbine blade comprises a turbine blade defining a blade tip having a surface, wherein the turbine blade comprises a base material, wherein the base material comprises a metal; a metallic coating or a bond coat disposed along the surface of the blade tip; and a thermal barrier coating disposed along a surface of the metallic coating or bond coat. The thermal barrier coating may comprise yttria stabilized zirconia, mullite, alumina, ceria, a rare-earth zirconate, a rare-earth oxide, a metal-glass composite, or combinations thereof and, in some embodiments, the metal of the base material may comprise a nickel superalloy.

In some embodiments, the coated turbine blade comprises a bond coat disposed along the surface of the blade tip, wherein the thermal barrier coating is disposed along the surface of the bond coat. In certain embodiments, the coated turbine blade comprises a metallic coating where the metallic coating is disposed along the surface of the blade tip, the thermal barrier coating is disposed along the surface of the metallic coating, and the metallic coating comprises a metallic mesh. In other embodiments, the coated turbine blade comprises a metallic coating where the metallic coating is disposed along the surface of the blade tip, the thermal barrier coating is disposed along the surface of the metallic coating, and the metallic coating comprises a metallic powder. The metallic coating may comprise a nickel superalloy, cobalt superalloy, iron superalloy, or combinations thereof.

In some embodiments, the coated turbine blade is configured to face a shroud of a high pressure turbine. The blade may have a blade tip with a width of about 30 mils to about 120 mils, such as about 30 mils to about 60 mils. The thermal barrier coating on the blade tip may have a thickness of about 25 to about 380 microns.

Aspects of the present disclosure are also directed to systems utilizing a coated blade tip. In some embodiments, the system comprises a turbine blade defining a blade tip having a surface, wherein the turbine blade comprises a base material, and a shroud comprising a ceramic matrix composite, wherein a thermal barrier coating is disposed along the surface of the blade tip, wherein the base material comprises a metal, and wherein the shroud is coated with an environmental barrier coating comprised of ytterbium yttrium disilicate. In certain embodiments, the thermal barrier coating comprises yttria stabilized zirconia. In some embodiments, the turbine blade metal comprises a nickel-superalloy and the blade tip may have a width of about 30 mils to about 120 mils.

In some embodiments of the present disclosure, the system further comprises a bond coat disposed along the surface of the blade tip, wherein the bond coat comprises platinum modified nickel aluminide. In certain embodiments, the system further comprises a metallic coating disposed along the surface of the blade tip, wherein the metallic coating comprises a metallic mesh, while in some embodiments, the system further comprises a metallic coating disposed along the surface of the blade tip, wherein the metallic coating comprises a metallic powder.

Aspects of the present disclosure are also directed to methods of preparing a coated turbine blade. In some embodiments, a method is provided for preparing a coated turbine blade configured for use with a ceramic matrix composite shroud coated with an environmental barrier coating. The method may comprise the steps of applying a metallic coating or a bond coat to a surface of a metal turbine blade, and applying a thermal barrier coating to a surface of the metallic coating or a surface of the bond coat.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 is a perspective view schematically representing an exemplary turbine blade comprising a coating system in accordance with one embodiment of the present disclosure;

FIG. 2 shows an exemplary coating system positioned on a blade tip of a turbine blade in accordance with one embodiment of the present disclosure;

FIG. 3 shows an exemplary coating system positioned on a blade tip of a turbine blade in accordance with one embodiment of the present disclosure;

FIG. 4 shows an exemplary coating system positioned on a blade tip of a turbine blade in accordance with one embodiment of the present disclosure;

FIG. 5 is a schematic cross-sectional view of a gas turbine engine in accordance with one embodiment of the present disclosure;

FIG. 6 is an enlarged cross sectional side view of a high pressure turbine portion of a gas turbine engine in accordance with one embodiment of the present disclosure;

FIG. 7 is a flowchart of a method of preparing a turbine blade comprising a coating system in accordance with one embodiment disclosed herein;

FIG. 8 provides a schematic of the interaction of a turbine blade and a shroud during a rubbing event;

FIGS. 9a-9b illustrate a testing apparatus for evaluating the coating system in accordance with at least one embodiment disclosed herein;

FIGS. 10a-10c are images of the formation of coated test coupons in accordance with at least one embodiment disclosed herein;

FIGS. 11a-11c are images of the formation of coated test coupons in accordance with at least one embodiment disclosed herein;

FIG. 12 is an image of a coated test coupon in accordance with at least one embodiment disclosed herein;

FIG. 13a illustrates the rubbing of a bare blade tip on EBC abradables;

FIG. 13b illustrates the rubbing of a coated blade tip in accordance with at least one embodiment disclosed herein;

FIG. 14 provides a summary of the measured rub ratios versus total incursions for bare and TBC coated blade tips in accordance with one embodiment disclosed herein.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “upstream” and “downstream” refer to the relative direction with respect to fluid flow in a fluid pathway. For example, “upstream” refers to the direction from which the fluid flows, and “downstream” refers to the direction to which the fluid flows.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth. As used herein, rare earth elements include, for example, scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or mixtures thereof.

As used herein, ceramic-matrix-composite or “CMCs” refers to silicon-containing, or oxide-oxide, matrix and reinforcing materials. Some examples of CMCs acceptable for use herein can include, but are not limited to, materials having a matrix and reinforcing fibers comprising non-oxide silicon-based materials such as silicon carbide, silicon nitride, silicon oxycarbides, silicon oxynitrides, and mixtures thereof. Examples include, but are not limited to, CMCs with a silicon carbide matrix and silicon carbide fiber; silicon nitride matrix and silicon carbide fiber; and silicon carbide/silicon nitride matrix mixture and silicon carbide fiber. Furthermore, CMCs can have a matrix and reinforcing fibers comprised of oxide ceramics. Specifically, the oxide-oxide CMCs may be comprised of a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃ 2SiO₂), as well as glassy aluminosilicates.

As used herein, environmental-barrier-coating or “EBCs” refers to a coating system comprising one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), alkaline earth aluminosilicates (e.g., comprising barium-strontium-aluminum silicate (BSAS), such as having a range of BaO, SrO, Al₂O₃, and/or SiO₂ compositions), hermetic layers (e.g., a rare earth disilicate), and/or outer coatings (e.g., comprising a rare earth monosilicate, such as slurry or APS-deposited yttrium monosilicate (YMS)). One or more layers may be doped as desired, and the EBC may also be coated with an abradable coating.

A coating system for a metallic turbine blade is generally provided herein, along with methods of forming such coating system. The composition of the coating system and the methods of applying the coating system to the turbine blade allow for application of a protective coating, such as a thermal barrier coating, to the narrow blade tip of the turbine blade. In one particular embodiment, the coating system provides improved thermal protection for the turbine blade tip and reduces the wear of the turbine blade tip, and is mechanically resistant to spall and rub in turbine engine environments. In one embodiment, the coating system is generally provided in combination with a CMC shroud coated with an EBC. When applied to a blade surface, the coating system improves the hardness of the blade (in particular during rubbing when the temperature can be much higher than the engine environmental temperature) such that the wear of the blade tip is reduced. Further, the coating can insulate the metallic blade tip from high temperatures at the rubbing interface, thereby reducing the blade tip temperature. Thus, the coating serves to protect the underlying metallic turbine blade from both softening and from wear.

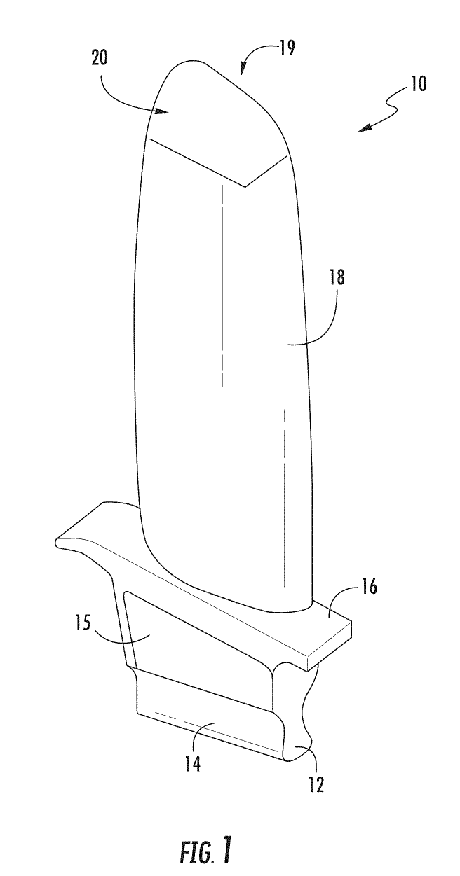

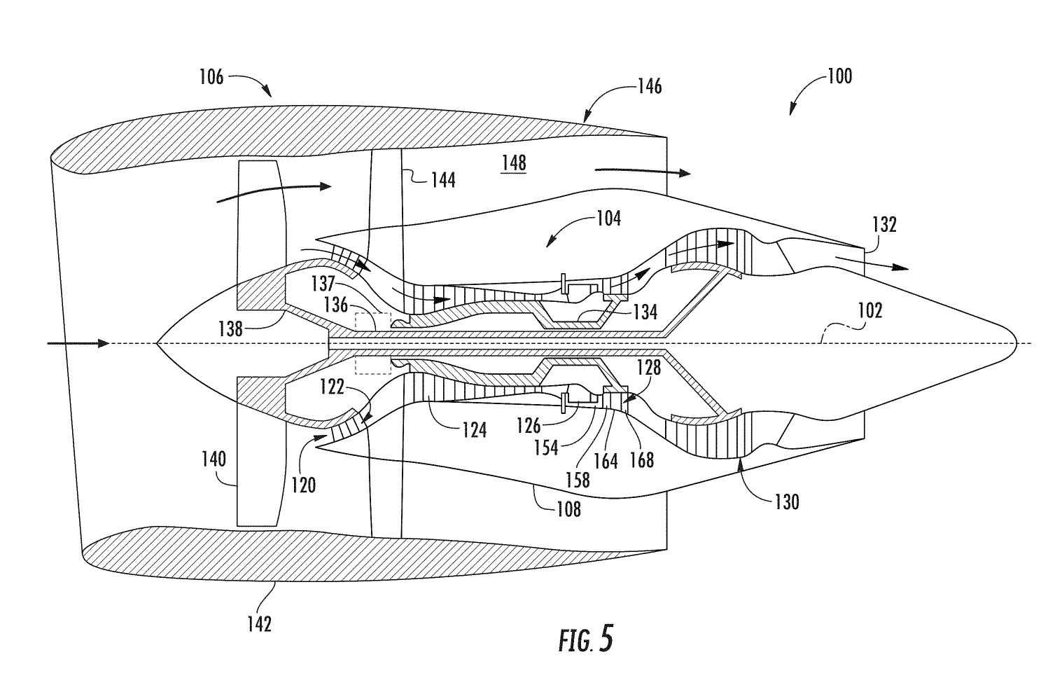

FIG. 1 shows an exemplary turbine blade 10 of a gas turbine engine. The blade 10 is generally represented as being adapted for mounting to a disk or rotor within the turbine section of an aircraft gas turbine engine (illustrated in FIGS. 5 and 6). For this reason, the blade 10 is represented as including a dovetail 12 for anchoring the blade 10 to a turbine disk by interlocking with a complementary dovetail slot formed in the circumference of the disk. As represented in FIG. 1, the interlocking features comprise protrusions referred to as tangs 14 that engage recesses defined by the dovetail slot. The blade 10 is further shown as having a platform 16 that separates an airfoil 18 from a shank 15 on which the dovetail 12 is defined.

The blade 10 includes a blade tip 19 disposed opposite the platform 16. As such, the blade tip 19 generally defines the radially outermost portion of the blade 10 and, thus, may be configured to be positioned adjacent to a stationary shroud (172, 174) illustrated in FIG. 6) of the gas turbine engine. As stated above, during use, the blade tip 19 may contact the shroud, causing a rub event between the blade tip 19 and the shroud. The blade tip 19 may also be referred to as the interface between the blade and the shroud and may be referred to as the rubbing area between the blade and the shroud.

As shown in FIG. 1, in this embodiment, the blade 10 is a generally elongated body with front and back surfaces as well as slightly rounded corners. At the top of the elongated body is the blade tip 19 which is a generally rounded edge with a width and depth. In some embodiments, the blade tip 19 may have an area of the blade tip 19 that is more pointed than other areas of the blade tip 19, and in some embodiments, the blade 10 may have a smooth transition from the airfoil 18 to the blade tip 19. In some embodiments, the blade tip 19 is covered with the coating system 20 such that the coating system 20 covers the rubbing area of the blade and shroud and becomes the interface between the blade and the shroud. The coating system 20 may cover the top of the blade tip 19 and extend at least partially over the front and back surfaces of the rounded blade tip 19 as shown in FIG. 1.

In one particular embodiment, the blade tip 19 may be further equipped with a blade tip shroud (not shown) which, in combination with tip shrouds of adjacent blades within the same stage, defines a band around the blades that is capable of reducing blade vibrations and improving airflow characteristics. By incorporating a seal tooth, blade tip shrouds are further capable of increasing the efficiency of the turbine by reducing combustion gas leakage between the blade tips and a shroud surrounding the blade tips.

Because the components are directly subjected to hot combustion gases during operation of the engine, the airfoil 18, platform 16, and blade tip 19 have very demanding material requirements. The platform 16 and blade tip 19 are further critical regions of a turbine blade in that they create the inner and outer flowpath surfaces for the hot gas path within the turbine section. In addition, the blade tip 19 is subjected to creep due to high strain loads and wear interactions between it and the shroud surrounding the blade tips 19.

In certain embodiments, the blade tip 19 comprises a base material. In some embodiments, the base material includes a metal such as steel or superalloys (e.g., nickel-based superalloys, cobalt-based superalloys, or iron-based superalloys, such as Rene N5, N500, N4, N2, IN718 or Haynes 188) or other suitable materials for withstanding high temperatures.

As shown in FIG. 1, in this embodiment, the blade tip 19 is coated with a coating system 20. The coating system 20 is disposed along the blade tip 19 in FIG. 1, and may be disposed along the blade tip 19 as well as other portions of the airfoil 18. The coating system 20 covers at least a portion of the blade tip 19, and in some cases, the coating system 20 covers the portion of the blade tip 19 most immediately adjacent to the shroud when positioned in the turbine section of the engine (see FIG. 6).

The coating system 20 is configured such that wear and softening of the blade tip 19 is reduced. During operation, the blade tip and shroud can face temperatures over about 2200° F. (1205° C.), such as over about 2300° F. (1260° C.), such as about 2300° F. (1260° C.) to about 2400° F. (1316° C.) upon rubbing. The coating system incorporates components that can withstand these high temperatures and protect the underlying metal from the high temperatures. For instance, in certain embodiments, the coating system 20 may comprise a thermal barrier coating (“TBC”) disposed along the blade tip 19.

As used herein, “TBC” or “TBCs” is used to refer to stabilized ceramics that can sustain a fairly high temperature gradient such that the coated metallic components can be operated at environmental temperatures higher than the metal's melting point. For instance, the TBC may be one or more of yttria stabilized zirconia (YSZ), mullite (3Al₂O₃-2SiO₂), alumina (Al₂O₃), ceria (CeO₂), rare-earth zirconates (e.g., La₂Zr₂O₇), rare-earth oxides (e.g., La₂O₃, Nb₂O₅, Pr₂O₃, CeO₂), and metal-glass composites, and combinations thereof (e.g., alumina and YSZ or ceria and YSZ). In the case of YSZ, by substituting a certain amount of zirconium ions (Zr⁴⁺) with slightly larger yttrium ions (Y³⁺), stable sintered xYSZ (x represents mol % of Yttrium ions, e.g., 8YSZ) can be obtained. The introduction of yttrium may help to minimize the volume changes accompanying phase transformation of zirconium dioxide, thus gaining the YSZ high temperature thermal stability. Besides the high temperature stability, YSZ also has a good combination of high hardness and chemical inertness, and the thermal expansion coefficient of YSZ can be tuned to match the metallic components of the turbine blade being coated. TBCs, such as YSZ, have a higher hardness than EBCs, such as YbYDS, and, thus, are less likely to wear off when in contact with EBCs.

The TBC may be formed by any suitable process. For instance, one or more TBCs may be formed by air-plasma spray (APS), electron beam physical vapor deposition (EBPVD), high velocity oxygen fuel (HVOF), electrostatic spray assisted vapor deposition (ESAVD), and direct vapor deposition. APS may allow for higher deposition rates and better coverage of a blade tip than EB PVD. However, the porous and lamellar nature of the sprayed coating from APS may limit the performance and life of the coating. TBC layers fabricated via EBPVD are often dense and may withstand high thermo-mechanical stresses due to the columnar structures of the layer, resulting in a strain tolerant coating. For application in a turbine, a TBC should be strongly bonded to the blade tip 19 for multiple thermal cycles. The coating should also be strong enough to cut-into any EBC abradables present on CMC shrouds.

In some embodiments, the TBC may be applied to a blade tip 19 to form one or more layers of TBC. In certain embodiments, the TBC may be applied to the blade tip 19 such that the TBC becomes dispersed throughout another layer, such as dispersed throughout a matrix of another component along the blade tip 19. In such an embodiment, the TBC phase can be a discontinuous phase within the matrix or a continuous phase within the matrix. One or more TBCs may be used along the blade tip 19. For instance, a plurality of TBCs may be applied to the blade tip 19 and may form one or more TBC layers along the blade tip 19.

Commercial aircraft engine blade tips are typically about 30 mils wide (about 760 microns). The present coating system can be applied to such narrow blade tips and still provide the above discussed benefits such as thermal protection and protection from blade wear. The coating system can generally be applied to blade tips less than about 300 mils wide and greater than about 30 mils wide, such as about 30 mils to about 120 mils wide, or about 30 mils to about 60 mils wide. The coating system may cover the entire width of the blade tip or may cover a portion of the width of the blade tip. Various alternative configurations are possible without deviating from the intent of the present disclosure.

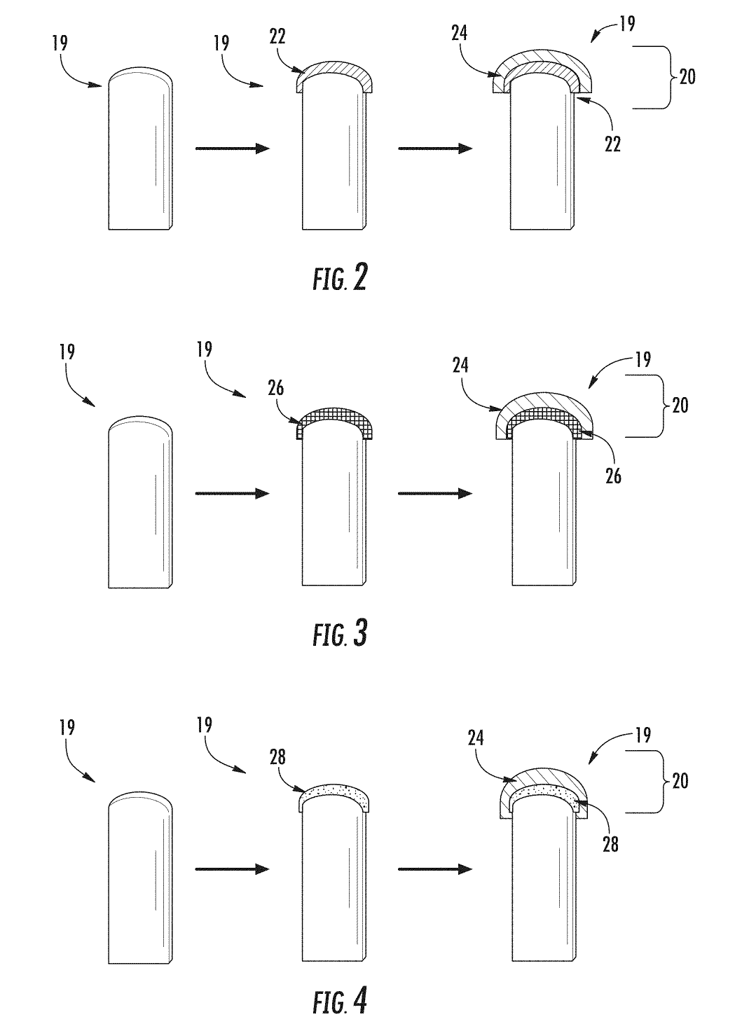

In some embodiments, the TBC may be used in conjunction with a bond coat applied prior to application of the TBC along the blade tip 19. FIG. 2 shows the formation of an exemplary coating system 20 positioned along a blade tip 19 of a turbine blade 10 in accordance with one embodiment of the present disclosure. As shown in FIG. 2, in this embodiment, the coating system 20 includes a TBC layer 24 and a bond coat 22 disposed along the blade tip 19.

As shown in FIG. 2, in this embodiment, the blade tip 19 is coated with a coating system 20. The coating system 20 is disposed along the blade tip 19 in FIG. 2, and may be disposed along the blade tip 19 as well as other portions of the airfoil 18 (shown in FIG. 1). The coating system 20 covers at least a portion of the blade tip 19, and in some cases, the coating system 20 covers the portion of the blade tip 19 most immediately adjacent to the shroud when positioned in the turbine section of the engine (see FIG. 6). As noted above, commercial aircraft engine blade tips are typically about 30 mils wide (about 760 microns). The present coating system can be applied to such narrow blade tips and still provide the above discussed benefits such as thermal protection and protection from blade wear.

The bond coat 22 may be any suitable bond coat 22 for improving the adherence of the TBC layer 24 to the underlying metallic blade tip 19. For instance, in some embodiments, a platinum modified nickel aluminide bond coat 22 may be formed on the blade tip 19 and then a TBC layer 24 may be applied to the platinum modified nickel aluminide bond coat 22. Without intending to be limiting, the bond coat 22 may help to release thermal stress during thermal cycles (e.g., rubbing—windage cooling—rubbing), thus reducing the occurrence of spallation of the TBC layer 24. The bond coat 22 may also prevent or reduce oxidation of the metallic blade tip 19 and prevent or reduce the accumulation of dirt between the TBC layer 24 and the blade tip 19, thereby also reducing spallation.

The TBC layer 24 may be about 1 micron to about 400 microns, such as about 25 microns to about 380 microns, about 50 microns to about 250 microns, or about 75 microns to about 200 microns thick. The bond coat 22 may be any suitable thickness to provide the desired benefits of improved adherence and reduced spallation. For instance, in some embodiments, the bond coat 22 may be about 1 micron to about 400 microns, such as about 25 microns to about 380 microns, about 50 microns to about 250 microns, or about 75 microns to about 200 microns thick. The bond coat may be formed by any suitable process.

One or more TBC layers 24, such as three, four, or five TBC layers 24 may be used along the blade tip 19. Multiple bond coats 22 may also be used between one or more TBC layers 24. Various alternative configurations are possible without deviating from the intent of the present disclosure.

In some embodiments, one or more TBC layers 24 may be used in conjunction with a metallic coating applied prior to application of one or more TBC layers 24 along the blade tip 19. Without intending to be bound by theory, the application of the metallic coating prior to application of a TBC layer 24 along the blade tip 19 may increase the effective bonding area for the TBC layer 24 to the blade tip allowing for application of the TBC layer 24 to the narrow blade tip 19. For instance, a layer of metal mesh or powder grits may be applied to the blade tip 19 prior to application of the TBC layer 24 to increase the surface area in contact with the TBC layer 24. The TBC layer 24 may then be applied to the metal mesh or powder grits to coat the pores of the metal mesh or the sides of the metal powder grit. Application of the metal mesh/powder may thereby provide improved mechanical strength of the TBC layer 24 and bonding strength of the TBC layer 24 to the blade tip 19.

FIG. 3 shows the formation of an exemplary coating system 20 positioned on a blade tip 19 of a turbine blade 10 in accordance with one embodiment of the present disclosure. As shown in FIG. 3, in this embodiment, the coating system 20 includes a TBC layer 24 and a metallic mesh 26 disposed along the blade tip 19.

As shown in FIG. 3, in this embodiment, the blade tip 19 is coated with a coating system 20. The coating system 20 is disposed along the blade tip 19 in FIG. 3, and may be disposed along the blade tip 19 as well as other portions of the airfoil 18 (shown in FIG. 1). The coating system 20 covers at least a portion of the blade tip 19, and in some cases, the coating system 20 covers the portion of the blade tip 19 most immediately adjacent to the shroud when positioned in the turbine section of the engine (see FIG. 6). As noted above, commercial aircraft engine blade tips are typically about 30 mils wide (about 760 microns). The present coating system can be applied to such narrow blade tips and still provide the above discussed benefits such as thermal protection and protection from blade wear.

The metallic mesh 26 may be formed by any suitable process and may comprise any suitable metal that improves the adherence between the applicable TBC layer 24 and the blade tip 19. For instance, the metallic mesh 26 may comprise any suitable metallic composition such as steel or superalloys (e.g., nickel-based superalloys, cobalt-based superalloys, or iron-based superalloys, such as Rene N5, N500, N4, N2, IN718, or Haynes 188) or other suitable materials for withstanding high temperatures, and may be formed along the blade tip 19 by brazing, welding, or other similar methods. For instance, the metallic mesh 26 may be a porous material formed from a plurality of metallic threads or wires woven or brazed together. The metallic mesh 26 may comprise a single layer of such woven or brazed threads or wires or may comprise multiple layers of woven or brazed threads or wires. In some embodiments, when brazing the metallic mesh to the blade tip, nickel chromium silicon (NiCrSi) or nickel chromium boron (NiCrB) may be used. In the case of NiCrB, boron may diffuse into the metallic mesh increasing the melt temperature of the braze material. The metallic mesh may have any suitable thread dimension, such as about 1 micron to about 400 microns, such as about 25 microns to about 380 microns, about 50 microns to about 250 microns, or about 75 microns to about 200 microns. The pore size and density of the metallic mesh may allow for the TBC layer 24 to coat the pores, thereby increasing the surface area for the TBC layer 24 to adhere and increasing the mechanical bonding strength of the TBC layer 24 to the blade tip 19.

FIG. 4 shows the formation of an exemplary coating system 20 positioned on a blade tip 19 of a turbine blade 10 in accordance with one embodiment of the present disclosure. As shown in FIG. 4, in this embodiment, the coating system 20 includes a TBC layer 24 and metallic powder 28 disposed along the blade tip 19.

As shown in FIG. 4, in this embodiment, the blade tip 19 is coated with a coating system 20. The coating system 20 is disposed along the blade tip 19 in FIG. 4, and may be disposed along the blade tip 19 as well as other portions of the airfoil 18 (shown in FIG. 1). The coating system 20 covers at least a portion of the blade tip 19, and in some cases, the coating system 20 covers the portion of the blade tip 19 most immediately adjacent to the shroud when positioned in the turbine section of the engine (see FIG. 6). As noted above, commercial aircraft engine blade tips are typically about 30 mils wide (about 760 microns). The present coating system can be applied to such narrow blade tips and still provide the above discussed benefits such as thermal protection and protection from blade wear.

The metallic powder 28 may be formed by any suitable process and may comprise any suitable metal that improves the adherence of the applicable TBC layer 24 to the blade tip 19. For instance, the metallic powder 28 may comprise any suitable metallic composition such as steel or superalloys (e.g., nickel-based superalloys, cobalt-based superalloys, or iron-based superalloys, such as Rene N5, N500, N4, N2, IN718, or Haynes 188) or other suitable materials for withstanding high temperatures, and may be formed along the blade tip 19 by brazing, welding, or other similar methods. For instance, when brazing the metallic powder to the blade tip, nickel chromium silicon (NiCrSi) or nickel chromium boron (NiCrB) may be used. In the case of NiCrB, boron may diffuse into the metallic powder increasing the melt temperature of the braze material. The metallic powder particles may have a mean diameter less than about 400 microns, such as about 1 micron to about 400 microns, such as about 25 microns to about 380 microns, about 50 microns to about 250 microns, or about 75 microns to about 200 microns. The size and density of the metallic powder particles may allow for the TBC layer 24 to coat the sides of the particles, thereby increasing the surface area for the TBC layer 24 to adhere and increasing the mechanical bonding strength of the TBC layer 24 to the blade tip 19.

In addition, in some embodiments, one or more TBC layers 24 may be applied to one or more bond coats 22, metallic meshes 26, metallic powders 28, or combinations thereof. For instance, in some embodiments, a bond coat 22 may be used in conjunction with a metallic mesh 26 and/or a metallic powder 28. In some embodiments, multiple layers of TBC layers 24 may be applied to the blade tip 19 with various combinations of a bond coat 22, metallic mesh 26, and metallic powder 28. The combination of one or more bond coats 22, metallic meshes 26, metallic powders 28, or combinations thereof with the TBC layer 24 may allow for a protective coating to be applied to a narrow blade tip 19 to improve blade wear.

The materials in the coating system can be selected to match closely the coefficient of thermal expansion (“CTE”) of the TBC layer 24 and/or the underlying metallic blade tip 19. CTE matching (or a near match) can enable the formation and operation of a dense, crack free coating system on the blade tip 19.

FIG. 5 is a schematic cross-sectional view of a gas turbine engine in accordance with one embodiment of the present disclosure. Although further described below generally with reference to a turbofan engine 100, the present disclosure is also applicable to turbomachinery in general, including turbojet, turboprop and turboshaft gas turbine engines, including industrial and marine gas turbine engines and auxiliary power units.

As shown in FIG. 5, the turbofan 100 has a longitudinal or axial centerline axis 102 that extends therethrough for reference purposes. In general, the turbofan 100 may include a core turbine or gas turbine engine 104 disposed downstream from a fan section 106.

The gas turbine engine 104 may generally include a substantially tubular outer casing 108 that defines an annular inlet 120. The outer casing 108 may be formed from multiple casings. The outer casing 108 encases, in serial flow relationship, a compressor section having a booster or low pressure (LP) compressor 122, a high pressure (HP) compressor 124, a combustion section 126, a turbine section including a high pressure (HP) turbine 128, a low pressure (LP) turbine 130, and a jet exhaust nozzle section 132. A high pressure (HP) shaft or spool 134 drivingly connects the HP turbine 128 to the HP compressor 124. A low pressure (LP) shaft or spool 136 drivingly connects the LP turbine 130 to the LP compressor 122. The (LP) spool 136 may also be connected to a fan spool or shaft 138 of the fan section 106. In particular embodiments, the (LP) spool 136 may be connected directly to the fan spool 138 such as in a direct-drive configuration. In alternative configurations, the (LP) spool 136 may be connected to the fan spool 138 via a speed reduction device 137 such as a reduction gear gearbox in an indirect-drive or geared-drive configuration. Such speed reduction devices may be included between any suitable shafts/spools within engine 100 as desired or required.

As shown in FIG. 5, the fan section 106 includes a plurality of fan blades 140 that are coupled to and that extend radially outwardly from the fan spool 138. An annular fan casing or nacelle 142 circumferentially surrounds the fan section 106 and/or at least a portion of the gas turbine engine 104. It should be appreciated by those of ordinary skill in the art that the nacelle 142 may be configured to be supported relative to the gas turbine engine 104 by a plurality of circumferentially-spaced outlet guide vanes 144. Moreover, a downstream section 146 of the nacelle 142 (downstream of the guide vanes 144) may extend over an outer portion of the gas turbine engine 104 so as to define a bypass airflow passage 148 therebetween.

FIG. 6 provides an enlarged cross sectioned view of the HP turbine 128 portion of the gas turbine engine 104 as shown in FIG. 5 and may incorporate various embodiments of the present invention. As shown in FIG.6, the HP turbine 128 includes, in serial flow relationship, a first stage 150 which includes an annular array 152 of stator vanes 154 (only one shown) axially spaced from an annular array 156 of turbine rotor blades 158 (only one shown) (also referred to as “turbine blades”). The HP turbine 128 further includes a second stage 160 which includes an annular array 162 of stator vanes 164 (only one shown) axially spaced from an annular array 166 of turbine rotor blades 168 (only one shown) (also referred to as “turbine blades”). The turbine rotor blades 158, 168 extend radially outwardly from and are coupled to the HP spool 134 (FIG. 5). As shown in FIG. 6, the stator vanes 154, 164 and the turbine rotor blades 158, 168 at least partially define a hot gas path 170 for routing combustion gases from the combustion section 126 (FIG. 5) through the HP turbine 128.

As further shown in FIG. 6, the HP turbine may include one or more shroud assemblies, each of which forms an annular ring about an annular array of turbine blades 158, 168. For example, a shroud assembly 172 may form an annular ring around the annular array 156 of turbine blades 158 of the first stage 150, and a shroud assembly 174 may form an annular ring around the annular array 166 of turbine blades 168 of the second stage 160. In general, shrouds of the shroud assemblies 172, 174 are radially spaced from blade tips 176, 178 of each of the turbine blades 158, 168. A radial or clearance gap CL is defined between the blade tips 176, 178 and inner surfaces 180, 182 of the shrouds of the shroud assemblies 172, 174, respectively. The shrouds and shroud assemblies generally reduce leakage from the hot gas path 170.

It should be noted that shrouds and shroud assemblies may additionally be utilized in a similar manner in the low pressure compressor 122, high pressure compressor 124, and/or low pressure turbine 130. Accordingly, shrouds and shrouds assemblies as disclosed herein are not limited to use in HP turbines, and rather may be utilized in any suitable section of a gas turbine engine.

While not illustrated in FIGS. 5 and 6, the blade tips 176, 178 may be coated with the coating system 20, which may include one or more TBC layers 24. The coating system 20 may also include one or more bond coats 22, metallic meshes 26, and/or metallic powders 28 as described above. Also not illustrated in FIGS. 5 and 6, the inner surfaces 180, 182 of the shrouds of the shroud assemblies 172, 174 may be coated with one or more EBCs. The shrouds may be formed of a CMC.

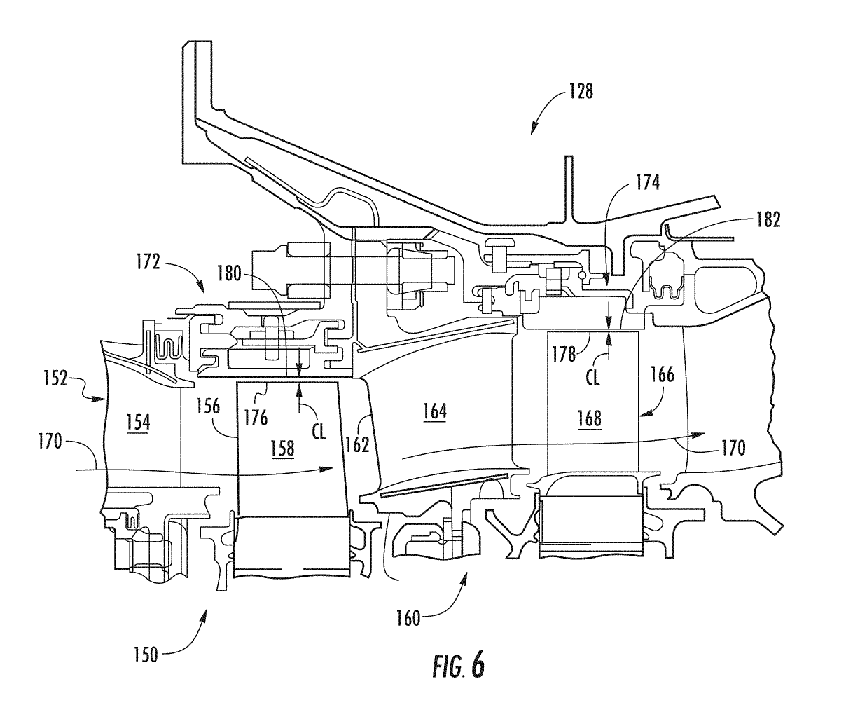

FIG. 7 is a flowchart of a method of preparing a turbine blade comprising a coating system in accordance with one embodiment disclosed herein. As shown in FIG. 7, in this embodiment, the method of preparing a turbine blade 500, particularly a coated turbine blade configured for use with a CMC shroud coated with an environmental barrier coating, comprises the step of applying a metallic coating to a surface of a metal turbine blade 510, and applying a thermal barrier coating to a surface of the metallic coating 520. For instance, a metallic coating such as a metallic mesh or metallic powder as described herein may be applied to a surface of a metal turbine blade, such as the surface of the blade tip. The metallic coating and thermal barrier coating may be applied by any suitable method as described herein. The method may comprise other treatments to the turbine blade and/or blade tip between each application of coating to further improve blade wear. In some embodiments, a bond coat may be applied in addition to or instead of the metallic coating.

While the present disclosure discusses turbine blades and shrouds present in the high pressure turbine, the principle of the coating system to cutoff metal transfer and thereby lower the rub ratio (blade wear/total incursion*100%) can be applied anywhere involving metallic rotor rubbings (e.g., high pressure turbines (HPT), low pressure turbines (LPT), high pressure compressor (HPC), low pressure compressor (LPC)). The coating system is particularly suitable for use at the interface of a metallic component and a ceramic component in high temperature environments, such as those present in gas turbine engines, for example, combustor components, turbine blades, shrouds, nozzles, heat shields, and vanes.

### EXAMPLES

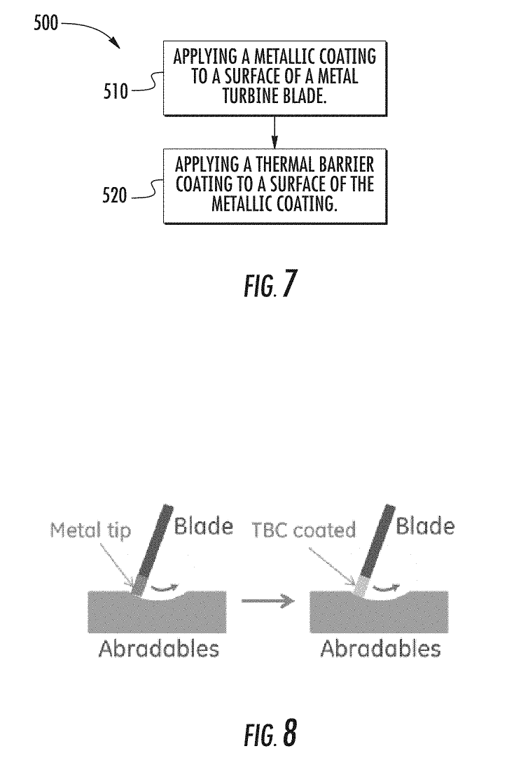

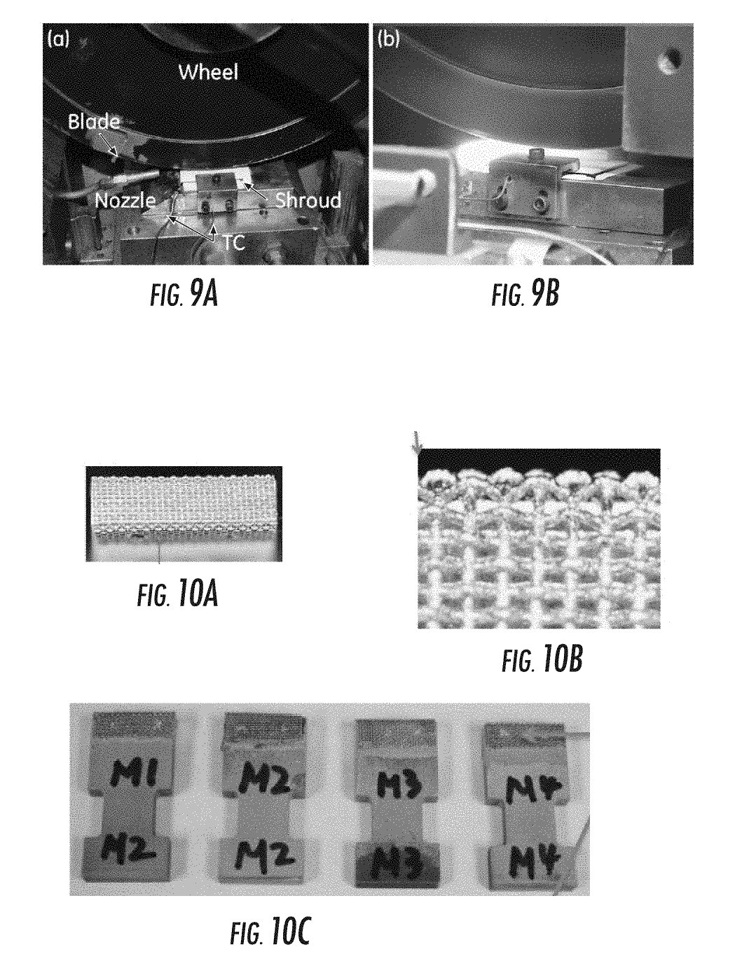

A rub rig (as shown in FIGS. 9a and 9b) at GE Global Research (seals lab, ATMS) was used to characterize and compare the rub ratio of uncoated blade coupons and blade coupons with the coating system. FIG. 9a is an image of the rub rig setup and FIG. 9b is an image of a test in progress. The blade coupons were rubbed against ytterbium yttrium disilicate EBC abradables.

When a metal blade tip rubs against an EBC (illustrated as “Abradables” in FIG. 8) coated shroud, the work applied on the blade tip via rubbing forces (up to hundreds of pounds force) may heat up the blade tip temperature reducing its strength. This may result in material loss from the blade and thus, a high rub ratio. However, a TBC coating on the blade tip may serve to protect the blade tip from softening and wear, resulting in a lower rub ratio.

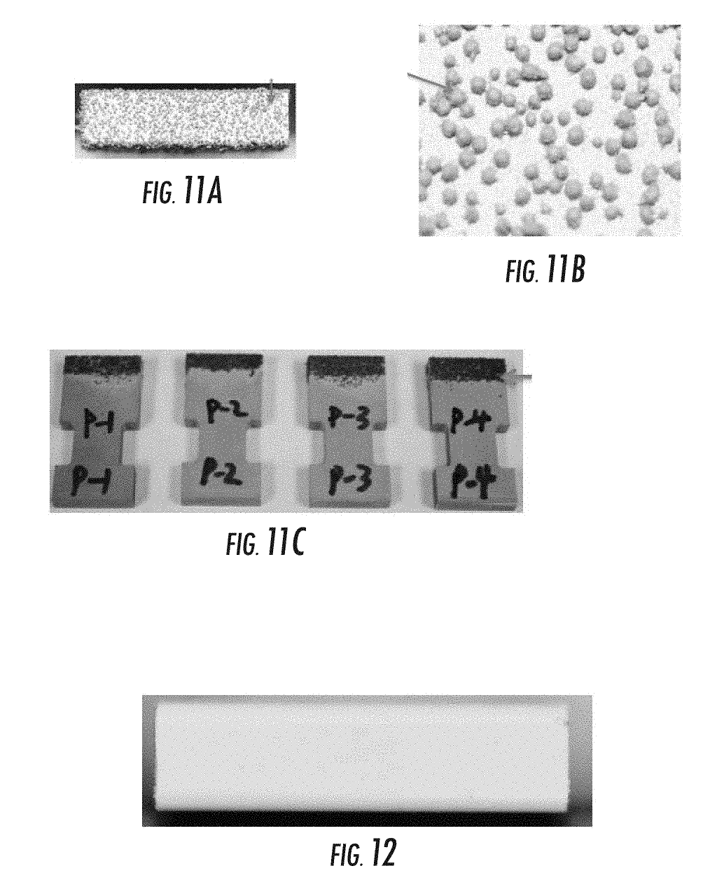

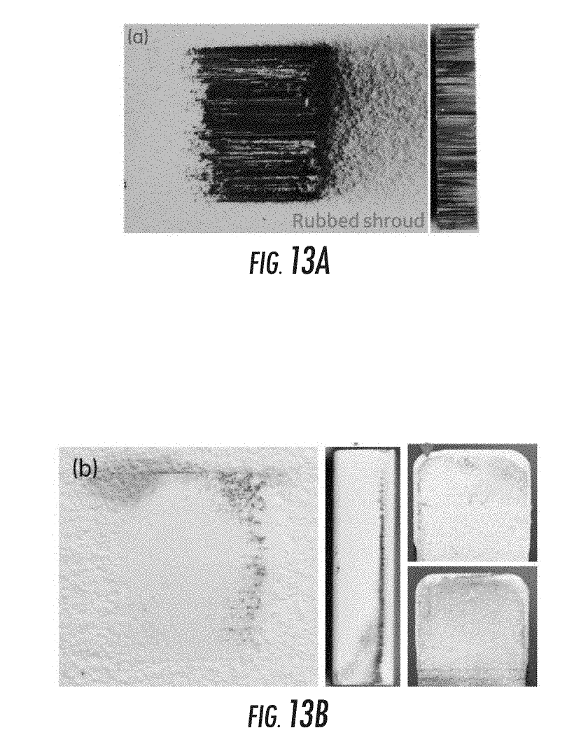

FIGS. 10a-10c show pre-treated blade coupons where the pre-treatment is the application of a metallic mesh. FIG. 10a is an image of one of the test coupons pre-treated with a metallic mesh by brazing, FIG. 10b is an enlarged view of FIG. 10a, and FIG. 10c is an image of four test coupons pre-treated with metallic mesh. FIGS. 11a-11c show pre-treated blade coupons where the pre-treatment is the application of a metallic powder. FIG. 11a is an image of one of the test coupons pre-treated with a metallic powder by brazing, FIG. 11b is an enlarged view of FIG. 11a, and FIG. 11c is an image of four test coupons pre-treated with metallic powder. The filter size of the metallic mesh was about 3 mils to about 8 mils and the mean diameter of the metallic powder was about 3 mils to about 10 mils.

FIG. 12 is an image of a blade coupon after deposition of a TBC layer over a bond coat.

FIG. 13a shows the results of a baseline test where a metal blade without a tip coating was used to rub against an EBC coating. The dark colored rub scar in FIG. 13a indicates that in this example, metal transferred from the blade tip, which was further shown by the irregular end profile of the blade tip. The test results indicated a high rub ratio. FIG. 13b show the results of a rub test where a metal blade with tip coatings was used to rub against an EBC coating. The rub scar in FIG. 13b indicates no metal transfer from the blade tip, and both top and side views of the blade tips indicated uniform TBC coverage after rub tests. These results indicated that the TBC coating was strongly bonded to the blade tip. The TBC coating successfully protected the blade tip from wear and, due to the higher hardness of the coating, cut into the softer EBC coating.

In certain cases, spallation of the EBC layer was observed. When spallation was observed for the EBC layer, the rub scar on the shroud was generally free of metal deposition and the rub ratio was reduced. Slight spallation of the TBC coating was observed in one case. However, in this case, the blended edges of the blade tip were uniformly covered by a layer of TBC, implying that the round-edge design of the test coupon helped the coating survive in rubbing events. The spallation of the TBC layer on the blade tip was seen in a case where the bond coat was not applied to the blade tip. Defects such as formation of an oxidation layer and dirt particles between the blade tip and the TBC layer may have resulted in poor or no bonding sites in the particular case. The blade coupons using a bond coat between the blade tip and the TBC layer generally showed good coverage of the blade tips with dense TBC coatings.

In certain cases, the blade tips pre-treated with metal powder grits showed poor cutability on EBC abradables, as indicated by a shallow rub trace on the shroud coating. Due to the uneven alignment of the blade to the shroud surface, the blade showed heavier rubbing on one side than the other, and thereby more grits with TBC layers peeled from the top section. The blade tip showed poor coverage of powder grits and TBC. For these test coupons pre-treated with metallic powder, the thickness of the TBC layer may not have been sufficient to cover the surface irregularities of the metallic powder. The poor coverage of TBC may have reduced the rubbing capability of the TBC layer. The TBC layer on the metallic powder grits-treated blade tips was neither flat nor dense, and the surface irregularities may have resulted in significantly higher contact pressures than a flat contact interface upon rubbing. As a result, the TBC layer together with embedded grits was removed from the blade tip in these tests more easily than might be desired.

In certain cases, the metal mesh-treated blade tip showed poor rubbing on EBC layers, which may be seen in the barely seen rubbing scars. A close-up look of the residual metal mesh on blade tip revealed that the mesh floated on the blade instead of tightly bonding to the blade.

The leading and trailing edges of the blade tip coupons however were well protected from being worn during rubbing when coated with metallic mesh or powder in these cases. By further enhancing the bonding strength of the metal mesh/grit to blade tips (via brazing) and minimizing the coating surface roughness (via grind), the metallic coatings may enhance the TBC bonding strength to blade tip and help protect the underlying metal blade. The metallic coatings may be particularly beneficial since the squealer tip of a turbine blade is much narrower than the test coupons, thus making it more challenging to apply a reliable TBC layer. As the metallic mesh/powder coating provides an increased surface area for application of the TBC layer, the metallic mesh/powder coating pre-treatment may be an even better method than the bond coat pre-treatment.

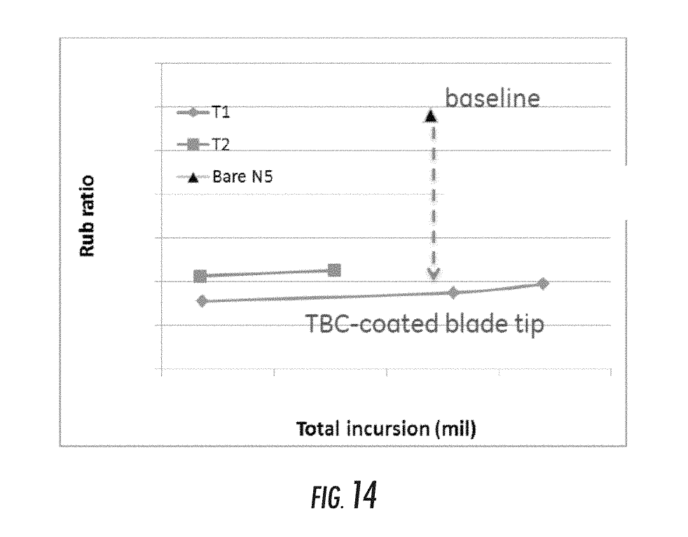

Reducing blade wear has been challenging for metallic blades. Regardless of the environmental temperature, the blade tip temperature can exceed the metal's softening point during high speed rubbing due to the high rubbing forces associated with high blade tip speed and relatively low thermal convection/conduction at the blade tip. Reducing the shroud coating stiffness benefits blade wear, but also can result in a shorter coating life. To minimize blade wear in a rubbing event, it has been found that blade materials with a higher strength and stiffness than the shroud materials can beneficially be applied to turbine blades, in particular blade tips. The inventors have found a feasible way of reducing the rub ratio by protecting the blade tip from overheating with the coating system. FIG. 14 compares the rub ratios obtained from bare metal blades (“Bare N5”) and TBC-coated blades (“T1” and “T2”). As shown in FIG. 14, the coating of the blade tip with TBC provided a drop in rub ratio of about 65% compared to bare blades.

A technical challenge of utilizing TBC coated blade tips is the assembly grind that is used to machine the blades in a rotor to the same height. This requires the TBC layer to be thick enough to tolerate the height difference among all blades in a rotor and to be thick enough such that the remaining TBC layer after grind can withstand rubbing during operation. The loss of a thick TBC layer would significantly affect HPT efficiency and increase the specific fuel consumption (SFC). Manufacturing and durability of a thick TBC layer on a relatively small blade tip will need to be considered for the coating system to be adopted in engine applications.

The coating system applied to the metal turbine blades in use with EBC-coated CMC shrouds provides reduced blade wear in rubbing events. Without intending to be bound by theory, the coating system functions by: (1) cutting into EBC layers due to the higher hardness of the coating system; and (2) isolating the metal blade tip from overheating during rubbing, thereby avoiding softening of the metal blade tip and transfer of the blade tip metal to the shroud. In comparison to a bare N5 blade, the rub ratio of a blade tip with the coating system on EBC abradables was reduced from about 60% to about 20%, implying about 4 mil clearance improvement for a 10 mil incursion.

While the invention has been described in terms of one or more particular embodiments, it is apparent that other forms could be adopted by one skilled in the art. It is to be understood that the use of “comprising” in conjunction with the coating compositions described herein specifically discloses and includes the embodiments wherein the coating compositions “consist essentially of” the named components (i.e., contain the named components and no other components that significantly adversely affect the basic and novel features disclosed), and embodiments wherein the coating compositions “consist of” the named components (i.e., contain only the named components except for contaminants which are naturally and inevitably present in each of the named components).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A coated turbine blade, the coated turbine blade comprising:
a turbine blade defining a blade tip having a surface, wherein the turbine blade comprises a base material, wherein the base material comprises a metal;
a metallic coating or a bond coat disposed along the surface of the blade tip; and
a thermal barrier coating disposed along a surface of the metallic coating or bond coat.

2. The coated turbine blade according to claim 1, wherein the bond coat is disposed along the surface of the blade tip and the thermal barrier coating is disposed along the surface of the bond coat.

3. The coated turbine blade according to claim 1, wherein the thermal barrier coating comprises yttria stabilized zirconia, mullite, alumina, ceria, a rare-earth zirconate, a rare-earth oxide, a metal-glass composite, or combinations thereof.

4. The coated turbine blade according to claim 1, wherein the thermal barrier coating comprises yttria stabilized zirconia.

5. The coated turbine blade according to claim 1, wherein the metal of the base material is a nickel-superalloy.

6. The coated turbine blade according to claim 1, wherein the metallic coating is disposed along the surface of the blade tip, the thermal barrier coating is disposed along the surface of the metallic coating, and the metallic coating comprises a metallic mesh.

7. The coated turbine blade according to claim 1, wherein the metallic coating is disposed along the surface of the blade tip, the thermal barrier coating is disposed along the surface of the metallic coating, and the metallic coating comprises a metallic powder.

8. The coated turbine blade according to claim 1, wherein the turbine blade is configured to face a shroud of a high pressure turbine.

9. The coated turbine blade according to claim 1, wherein the blade tip has a width of about 30 mils to about 120 mils.

10. The coated turbine blade according to claim 1, wherein the thermal barrier coating has a thickness of about 25 to about 380 microns.

11. The coated turbine blade according to claim 1, wherein the metallic coating comprises a nickel superalloy, cobalt superalloy, iron superalloy, or combinations thereof.

12. A system comprising:
a turbine blade defining a blade tip having a surface, wherein the turbine blade comprises a base material, and
a shroud comprising a ceramic matrix composite,
wherein a thermal barrier coating is disposed along the surface of the blade tip, wherein the base material comprises a metal, and wherein the shroud is coated with an environmental barrier coating.

13. The system according to claim 12, wherein the thermal barrier coating comprises yttria stabilized zirconia.

14. The system according to claim 12, wherein the turbine blade metal comprises a nickel-superalloy.

15. The system according to claim 12, further comprising a bond coat disposed along the surface of the blade tip, wherein the bond coat comprises platinum modified nickel aluminide.

16. The system according to claim 12, further comprising a metallic coating disposed along the surface of the blade tip, wherein the metallic coating comprises a metallic mesh.

17. The system according to claim 12, further comprising a metallic coating disposed along the surface of the blade tip, wherein the metallic coating comprises a metallic powder.

18. The system according to claim 12, wherein the environmental barrier coating comprises ytterbium yttrium disilicate.

19. The system according to claim 12, wherein the blade tip has a width of about 30 mils to about 120 mils.

20. A method of preparing a coated turbine blade configured for use with a ceramic matrix composite shroud coated with an environmental barrier coating, the method comprising:
applying a metallic coating or a bond coat to a surface of a metal turbine blade, and
applying a thermal barrier coating to a surface of the metallic coating or a surface of the bond coat.
